(19) United States
(12) Patent Application Publication
(10) Pub. No.: US 2013/0045722 A1
(43) Pub. Date: Feb. 21, 2013

(54) INFORMATION EXCHANGE METHOD, MOBILE COMMUNICATION TERMINAL APPARATUS AND COMPUTER READABLE INFORMATION RECORDING MEDIUM

(71) Applicant: Hikaru TOMODA, Kawasaki (JP)

(72) Inventor: Hikaru TOMODA, Kawasaki (JP)

(73) Assignee: FUJITSU MOBILE COMMUNICATIONS LIMITED, Kawasaki-shi (JP)

(21) Appl. No.: 13/567,536

(22) Filed: Aug. 6, 2012

(30) Foreign Application Priority Data
Aug. 18, 2011 (JP) 2011-179170

(51) Int. Cl. H04W 4/00

(52) U.S. Cl. 455/414.1

(57) ABSTRACT

A first mobile communication terminal apparatus reads exchange target information from a memory, attaches identification information for indicating as being the exchange target information to the exchange target information, and transmits the exchange target information to a second mobile communication terminal apparatus. The second mobile communication terminal apparatus stores the exchange information in a memory, and when having determined that the identification information is attached to the exchange target information, reads exchange target information stored in a memory, transmits the read exchange information to the first mobile communication terminal apparatus in return. The first mobile communication terminal apparatus receives the exchange target information transmitted from the second mobile communication terminal apparatus in return, and stores the received exchange target information in the memory.

### CROSS-REFERENCE TO RELATED APPLICATIONS

This application is based upon and claims the benefit of priority of the prior Japanese Patent Application No. 2011-179170, filed on Aug. 18, 2011, the entire contents of which are incorporated herein by reference.

### FIELD

The embodiments discussed herein are directed to an information exchange method, a mobile communication terminal apparatus and a computer readable information recording medium for exchanging information between mobile communication terminal apparatuses.

### BACKGROUND

A portable telephone can store profile information such as the name of the user, the telephone number, the mail address and so forth of the portable telephone. Further, in a telephone directory of a portable telephone, the names, the telephone numbers, the mail addresses and so forth of persons with whom a telephone call and/or mail communication is carried out can be stored. Also, portable telephones have been provided which have short distance wireless communication devices such as those using infrared communication, Bluetooth (registered trademark) communication or the like. In a case where persons have such portable telephones, they can exchange information such as profile information or telephone directory information.

FIG. 1 depicts a flowchart of one example of profile information exchange in the related art. A portable telephone A reads profile information from an internal memory in step S1. It is noted that hereinafter the portable telephone A may be also referred to as a terminal A. The portable telephone A transmits the profile information through infrared communication in step S2. The portable telephone A completes the transmission through infrared communication in step S3. On the other hand, a portable telephone B starts up an infrared menu in step S11. It is noted that hereinafter the portable telephone B may be also referred to as a terminal B. The portable telephone B receives the profile information through infrared communication in step S12. The portable telephone B completes the reception through infrared communication in step S13, and the user of the portable telephone B confirms registration of the received profile information in step S14.

Next, the portable telephone B reads profile information from an internal memory in step S15. The portable telephone B transmits the profile information through infrared communication in step S16. The portable telephone B completes the transmission through infrared communication in step S17. On the other hand, the portable telephone A starts up an infrared menu in step S4. The portable telephone A receives the profile information through infrared communication in step S5. The portable telephone A completes the reception through infrared communication in step S6, and the user of the portable telephone A confirms registration of the received profile information in step S7.

A technology has been proposed (for example, see Patent reference No. 1, mentioned below), in which when profile information or telephone directory data are exchanged between portable telephones, one portable telephone automatically switches into a reception mode after transmitting data to the other. Then, after receiving the data, the other portable telephone displays a selection screen page for determining whether to transmit data in return. Then, when a selection to transmit data in return has been made by the user, the other portable telephone transmits data in return.

### Patent Reference:

Patent reference No. 1: Japanese Laid-Open Patent Application No. 2008-236444

In the profile information exchange method in the related art depicted in FIG. 1, first the user of the portable telephone A operates the portable telephone A to transmit profile information. The user of the portable telephone B operates the portable telephone B to receive the profile information. After the user of the portable telephone B has confirmed the completion of the reception of the profile information of the user of the portable telephone A, the respective users of the portable telephones A and B switch their transmission and reception sides. The user of the portable telephone B then operates the portable telephone B to transmit profile information. The user of the portable telephone A operates the portable telephone A to receive the profile information. Thus, in the related art, the respective operations of the user of the portable telephone A and the user of the portable telephone B may be complicated.

Further, in the above-mentioned technology of Patent reference No. 1, one portable telephone automatically switches into a reception mode after transmitting data to the other portable telephone. Then, after receiving the data, the other portable telephone displays a selection screen page for determining whether to transmit data in return. Then, when a selection to transmit data in return has been made by the user of the other portable telephone, the other portable telephone transmits data in return. Thus, in this technology, after receiving the data, the user of the other portable telephone makes a selection using the selection screen page as to whether to transmit data in return. Thus, also the operations may be complicated.

### SUMMARY

In an information exchange method according to one aspect of the present invention, a first mobile communication terminal apparatus and a second mobile communication terminal apparatus exchange target information that is information to be exchanged.

In the information exchange method, the first mobile communication terminal apparatus reads exchange target information of the first mobile communication terminal apparatus itself stored in a memory, attaches identification information for indicating as being the exchange target information to the exchange target information, and transmits the exchange target information to the second mobile communication terminal apparatus.

The second mobile communication terminal apparatus stores the exchange target information in a memory, and when having analyzed and determined that the identification information is attached to the exchange target information, reads exchange target information of the second mobile communication terminal apparatus itself stored in the memory, and transmits the read exchange target information to the first mobile communication terminal apparatus in return.

The first mobile communication terminal apparatus receives the exchange target information transmitted from the second mobile communication terminal apparatus in return, and stores the received exchange target information in the memory.

The object and advantages of the disclosure will be realized and attained by means of the elements and combinations particularly pointed out in the claims.

It is to be understood that both the foregoing general description and the following detailed description are exemplary and explanatory only and are not restrictive of the invention, as claimed.

### BRIEF DESCRIPTION OF DRAWINGS

FIG. 1 illustrates a flowchart of one example of a profile information exchange process in the related art;

FIG. 2 is a configuration diagram of one embodiment of a mobile communication terminal apparatus;

FIGS. 3A, 3B and 3C depict telephone directory data;

FIG. 4 depicts profile information;

FIG. 5 depicts profile information at a time of being exchanged;

FIG. 6 illustrates a flowchart of a profile information exchange process;

FIG. 7 illustrates another flowchart of the profile information exchange process;

FIG. 8 illustrates a flowchart of the whole process at a time of profile information exchange according to a first embodiment of the present invention;

FIG. 9 illustrates a flowchart of the whole process at a time of profile information exchange according to a second embodiment of the present invention;

FIGS. 10A, 10B and 10C depict a data format of profile information used in infrared communication; and

FIGS. 11A, 11B and 11C depict a data format of profile information used in short distance wireless communication.

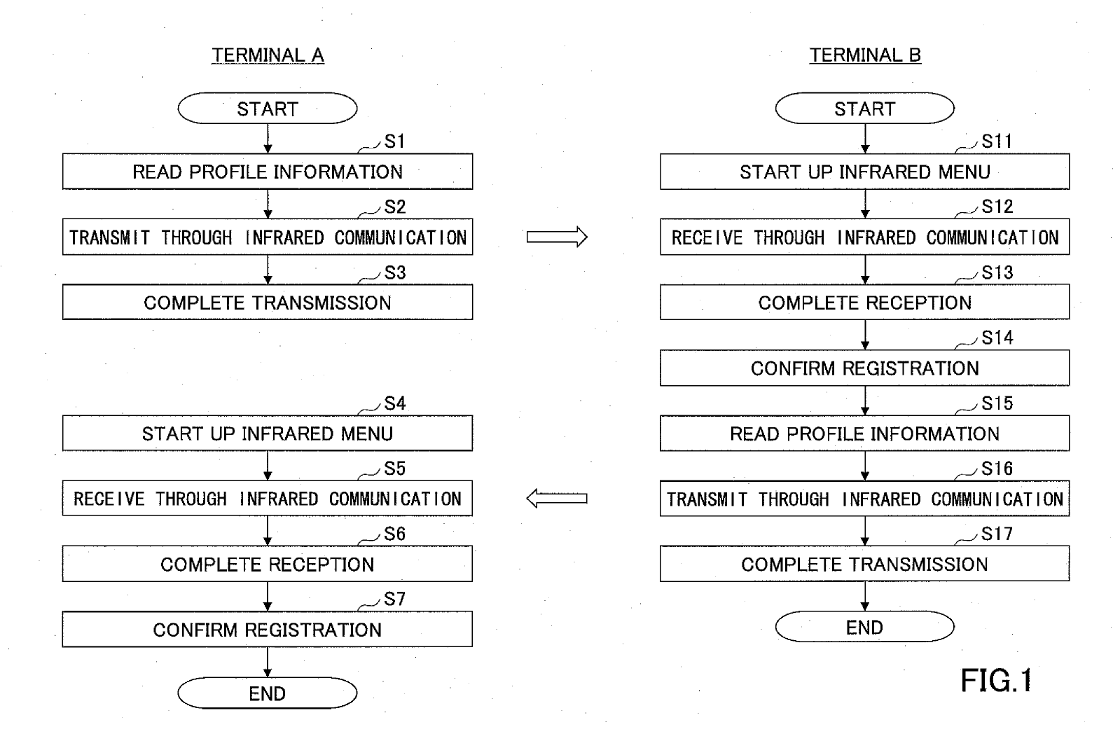

### DESCRIPTION OF EMBODIMENTS

Below, the embodiments of the present invention will be described using figures.

### <Configuration of Mobile Communication Terminal Apparatus>

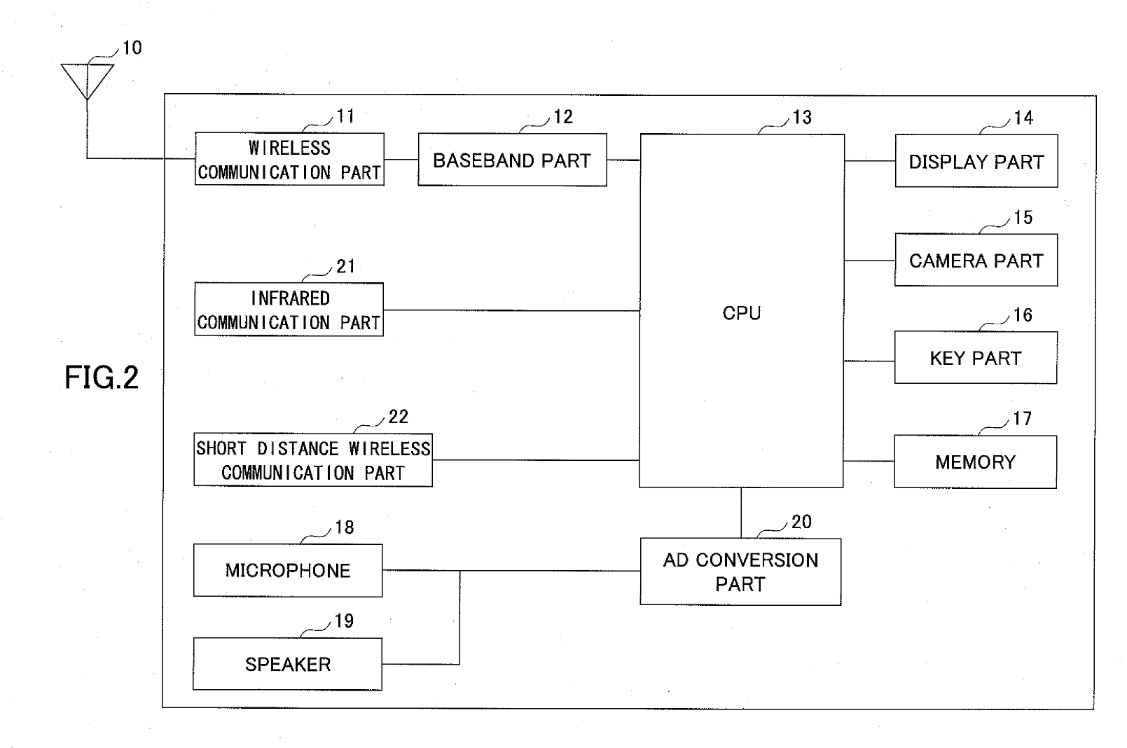

FIG. 2 depicts a configuration of a mobile communication terminal apparatus according to an embodiment of the present invention. Here, a portable telephone is depicted as one example of the mobile communication terminal apparatus. In FIG. 2, the portable telephone includes an antenna 10, a wireless communication part 11, a baseband part 12, a central processing unit (CPU) 13, a display part 14, a camera part 15, a key part 16, a memory 17, a microphone 18, a speaker 19, an analog-to-digital/digital-to-analog (AD) conversion part 20, an infrared communication part 21, and a short distance wireless communication part 22.

The wireless communication part 11 modulates a transmission signal provided by the baseband part 12 and transmits the modulated transmission signal to a base station (not depicted) through the antenna. The wireless communication part 11 demodulates a reception signal received through the antenna 10 and provides the demodulated reception signal to the baseband part 12. The baseband part 12 encodes the transmission signal provided by the CPU 13 and provides the encoded transmission signal to the wireless communication part 11. The baseband part 12 decodes the reception signal provided by the wireless communication part 11 and provides the decoded reception signal to the CPU 13.

The CPU 13 executes programs prepared for various processes stored in a Read Only Memory (ROM) included in the memory 17. In a case where the transmission/reception signals are sound signals, the CPU 13 provides the transmission signal from the AD conversion part 20 to the baseband part 12, and provides the reception signal from the baseband part to the AD conversion part 20. In a case where the transmission/reception signals are data, the CPU 13 provides the transmission data provided by the camera part 15, the memory 17 or the like, to the baseband part 12, and provides the reception data provided by the baseband part 12 to the display part 14, the memory 17 or the like.

The AD conversion part 20 digitizes an analog sound signal converted by the microphone 18 and provides the digital sound signal to the CPU 13. The AD conversion part 20 converts a digital sound signal provided by the CPU 13 to an analog signal, and provides the analog signal to the speaker 19 that generates a sound.

The display part 14 includes, for example, a liquid crystal panel, and displays various character information or image information under the control of the CPU 13. The camera part 15 takes a picture or takes an image, the image signal thus obtained is provided to the CPU 13, and then, may be stored in a Random Access Memory (RAM) of the memory 17. The key part 17 has various keys such as a ten key, a telephone call key, a selection key, a determination key, a clear key, and so forth, to be used for inputting a telephone number, characters, and so forth, and the input from the key part 17 is provided to the CPU 13.

The infrared communication part 21 carries out transmission and reception of data including profile information and telephone directory data which are exchange target information through infrared rays with an infrared communication part of another portable telephone. Further, the short distance wireless communication part 22 carries out transmission and reception of data including profile information and telephone directory data through short distance communication such as Bluetooth (registered trademark) with a short distance wireless communication part of another portable telephone. It is noted that infrared communication is a type of wireless communication.

Profile information including the user's name, the telephone number, the mail address and so forth of the portable telephone, and telephone directory data including the names, telephone numbers, mail addresses and so forth of persons with whom a telephone call or mail communication may be carried out are stored in a non-volatile memory, for example, an Electrically Erasable Programmable Read Only Memory (EEPROM) included in the memory 17.

In order to transmit profile information, the user causes a sub-menu to be displayed on an information display screen of the display part 14, and selects the infrared communication part 21 or the short distance wireless communication part 22. At a time of carrying out the communication, the CPU 13 attaches a “profile information tag” to the profile information. The profile information to which the profile information tag is attached is transmitted to a portable telephone of another person to whom the profile information is to be transmitted through the infrared communication part 21 or the short distance wireless communication part 22.

<vCard>

Telephone directory information of a portable telephone is information according to a standard format for electronic business cards called “vCard”. In a case where a telephone directory is stored in the memory 17 of the portable telephone, the profile information of the user is also stored as text data having the vCard format the same as that of the telephone directory information. It is noted that “vCard” has been recommended as RFC2425, 2426 by Internet Engineering Task Force (IETF) which is a standardizing association concerning Internet technology.

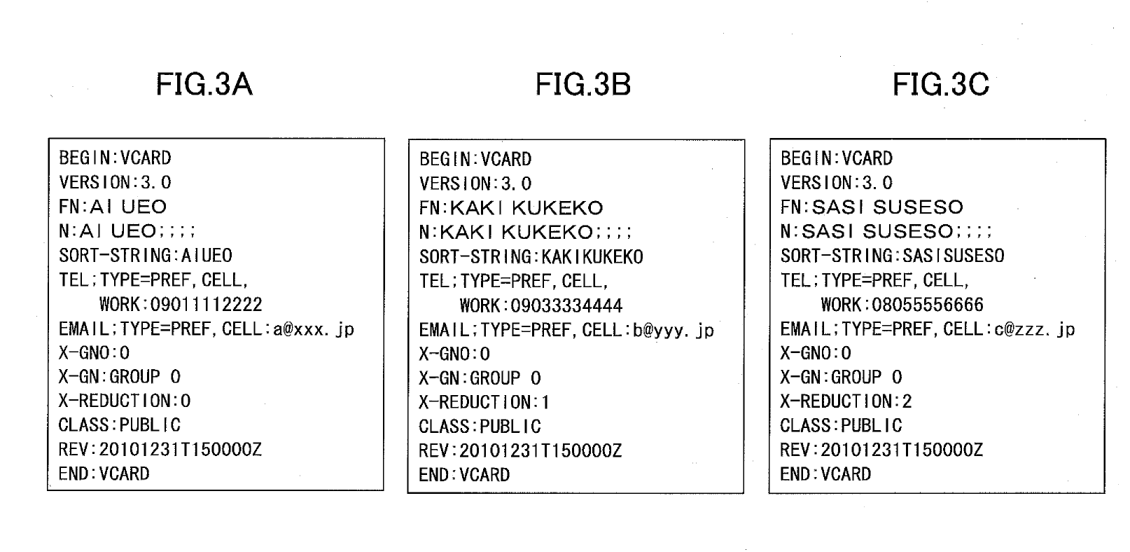

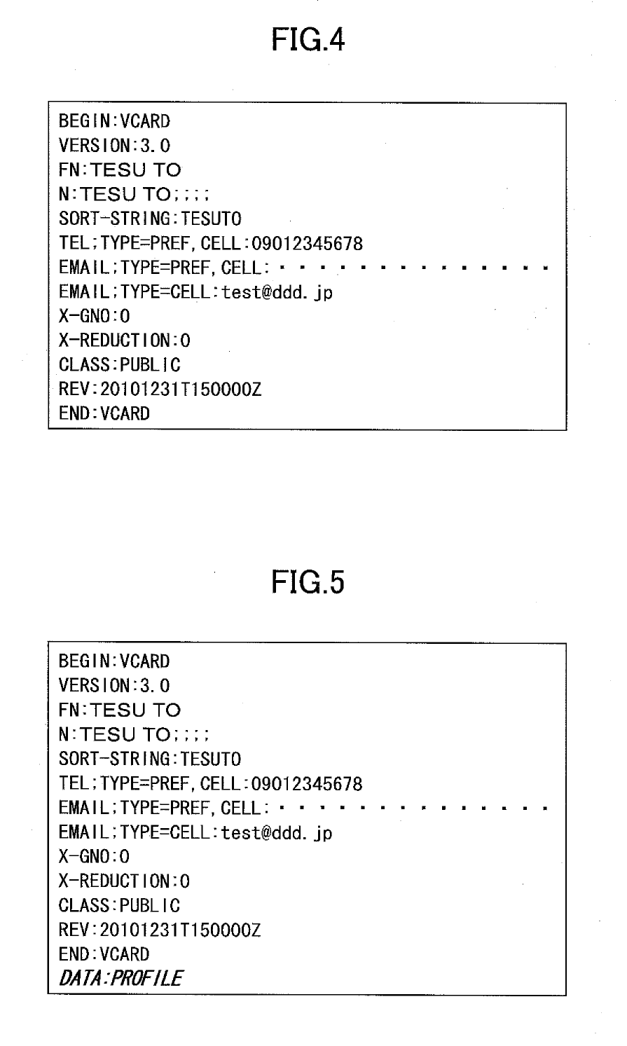

FIG. 3A depicts telephone directory data, i.e., telephone directory information including user's name “AI UEO”, telephone number “090-1111-2222” and mail address “a@xxx.jp”. Further, FIG. 3B depicts telephone directory data including user's name “KAKI KUKEKO”, telephone number “090-3333-4444” and mail address “b@yyy.jp”. Further, FIG. 3C depicts telephone directory data including user's name “SASI SUSESO”, telephone number “080-5555-6666” and mail address “c@zzz.jp”. Further, FIG. 4 depicts user's profile information that is exchange target information to be exchanged with another mobile communication terminal apparatus and is stored as part of telephone directory information. The profile information of FIG. 4 includes user's name “TESU TO”, telephone number “090-1234-5678” and mail address “test@ddd.jp”.

When profile information is exchanged, the CPU 13 attaches a profile information tag to the data of the user's profile information depicted in FIG. 4 and transmits the profile information. The profile information tag is identification information to be used for determining the attribute as being “profile information”.

FIG. 5 depicts the user's profile information to which a profile information tag has been attached. In FIG. 5, the profile information tag “DATA: PROFILE” is attached at the end of the profile information, as depicted.

A portable telephone at a reception side having received the profile information reads the profile information tag and, when having determined to have completed the reception of the profile information, can determine whether to transmit profile information of the portable telephone at the reception side itself. Further, the portable telephone at the transmission side can determine whether to subsequently receive the profile information.

Since information according to vCard is text information, it is easy to attach a “profile information tag” as identification information to be used for determining the attribute. The identification information is attached only when profile information is exchanged, is then deleted when the exchange of the profile information has been finished, and then, the profile information is stored as ordinary vCard data. Thus, it is possible to handle the profile data in the same way as existing data.

It is noted that in a case where a profile information tag other than those according to an existing format is used, the part of profile information corresponding to the profile information tag is discarded when the profile information is registered in a telephone directory. Therefore, even when an exchange of profile information is carried out using a profiled information tag with a portable telephone that does not support the profile information exchange method, the portable telephone can receive and register the profile information.

### <Flowchart of Transmission-Side Profile Information Exchange Process>

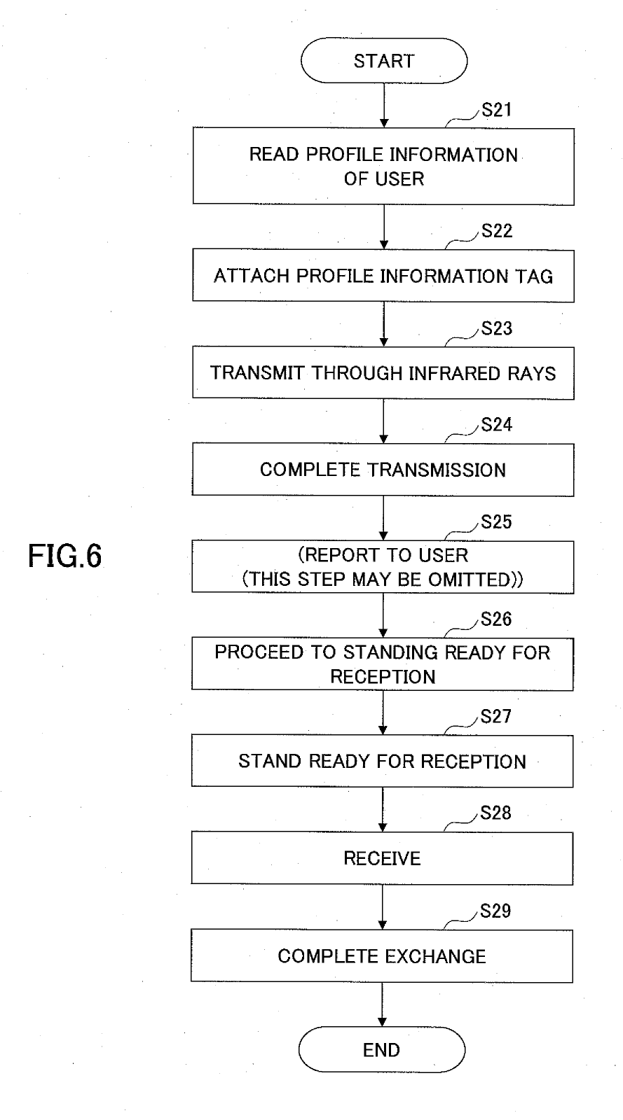

FIG. 6 depicts a flowchart of a profile information exchange process carried out by the CPU 13 at a portable telephone at a side of first transmitting profile information at a time of an exchange of profile information. A program of the profile information exchange process is stored in the memory 17, and the program of the profile information exchange process read from the memory 17 is executed by the CPU 13.

In FIG. 6, a user designates an exchange of profile information, starts up the sub-menu in the portable telephone, and selects infrared transmission (or short distance wireless transmission). Thereby, the CPU 13 understands in step S21 that the user's profile information is to be transmitted, and reads the profile information depicted in FIG. 4 from the memory 17.

Then, the CPU 13 attaches the profile information tag to the read profile information in step S22 so that the profile information has the form depicted in FIG. 5. Next, the CPU 13 carries out a process of infrared transmission (or short distance wireless transmission) of the profile information to which the profile information tag has been attached, in step S23

Next, when having received a response from another portable telephone indicating that it has completed reception of the profile information, the CPU 13 understands that the transmission of the profile information has been completed, in step S24. Then, the CPU 13 reports this matter to the user by displaying “transmission completion” on the display part 14, in step S25. It is noted that execution of step S25 is not indispensable and may be omitted. Then, in step S26, the CPU 13 enters a state of waiting for infrared reception (or short distance wireless reception). Then, in step S27, the CPU 13 stands ready for reception for a certain period of time (for example, on the order from several seconds to several minutes).

After that, when infrared transmission (or short distance wireless transmission) of profile information has been started by the other portable telephone, the CPU 13 carries out infrared reception (or short distance wireless reception) of the profile information in step S28. After that, in step S29, the CPU 13 stores the received profile information in the telephone directory of the memory 17, completes the infrared reception (or short distance wireless reception), sends a response to the other portable telephone to indicates the completion of the reception, and finishes the process.

### <Flowchart of Reception-Side Profile Information Exchange Process>

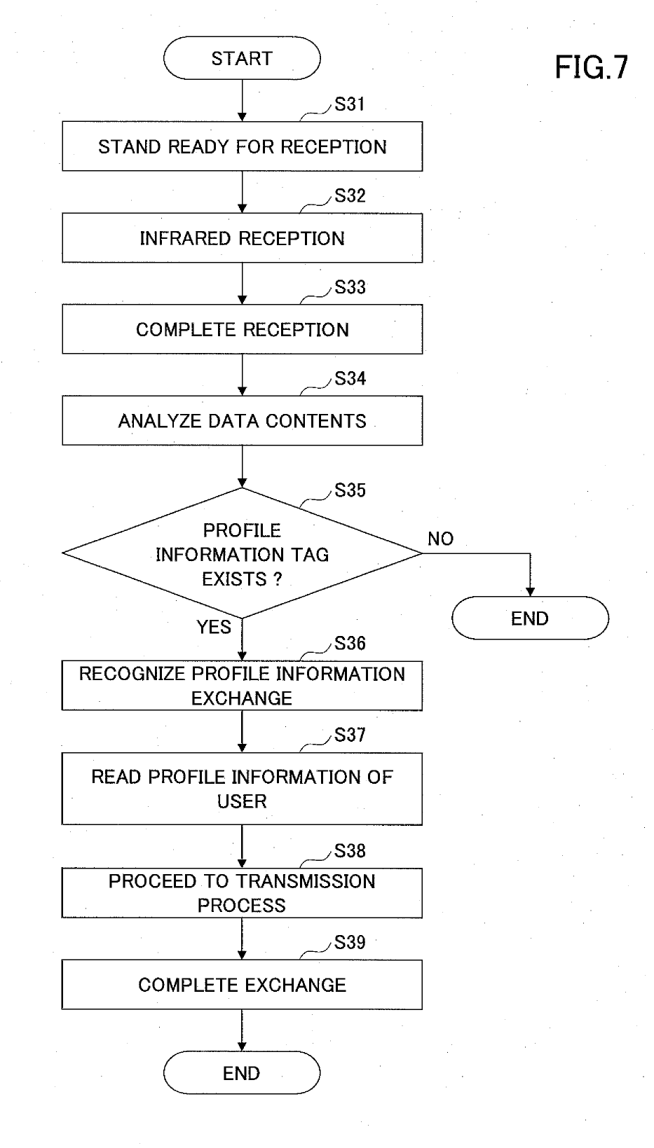

FIG. 7 depicts a flowchart of a profile information exchange process carried out by the CPU 13 at a portable telephone at a side of first receiving profile information at a time of an exchange of profile information. In FIG. 7, when the user designates an exchange of profile information, starts up the sub-menu and selects infrared reception (or short distance wireless reception), the CPU 13 stands ready for reception in step S31. Then, when infrared transmission (or short distance wireless transmission) of profile information has been started by another portable telephone, the CPU 13 carries out infrared reception (or short distance wireless reception) of the profile information, in step S32.

After that, in step S33, the CPU 13 writes and stores the received profile information in a telephone directory of the memory 17, and completes the infrared reception (or short distance wireless reception). It is noted that even when the profile information tag has been attached to the profile information, the profile information tag is not written in the telephone directory at a time when the profile information is written in the telephone directory. This is because the profile information tag “DATA: PROFILE” does not conform to the standard of vCard, and existing software of transmitting/receiving profile information discards the profile information tag that does not conform to the standard of vCard.

Next, the CPU 13 analyzes whether the profile information tag has been attached to the received profile information, in step S34. When the profile information tag has not been attached to the profile information from the analysis result (step S35 NO), the CPU 13 finishes the process.

On the other hand, when the profile information tag has been attached to the received profile information, the CPU 13 understands that the current process is a process of an exchange of profile information, in step S36. Then, the CPU 13 reads profile information of the own portable telephone such as that depicted in FIG. 4 stored in the memory 17 of the own portable telephone, in step S37.

After that, in step S38, the CPU 13 enters a state of infrared transmission (or short distance wireless transmission), and carries out infrared transmission (or short distance wireless transmission) of the profile information. It is noted that in step S38, the profile information such as that depicted in FIG. 4 to which the profile information has not been attached is sent in return. Then, when having received a response from the other portable telephone indicating the completion of the reception, the CPU 13 understands that the transmission has been completed, in step S39, and finishes the process.

### <First Embodiment of Whole Process at Time of Profile Information Exchange>

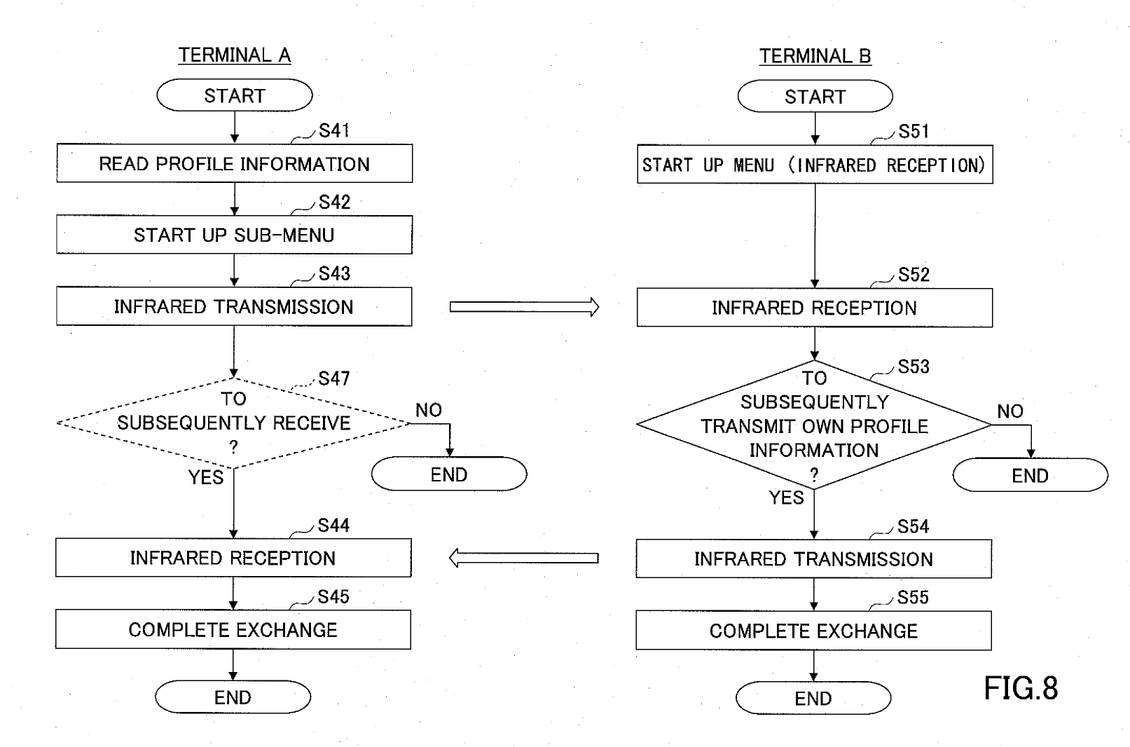

FIG. 8 depicts a flowchart of a whole process at a time of a profile information exchange according to a first embodiment of the present invention. According to the first embodiment, a case is assumed where both a portable telephone A and a portable telephone B are capable of attaching and identifying the profile information tag. It is noted that the portable telephone A may be referred to as a terminal A and the portable telephone B may be referred to as a terminal B.

In FIG. 8, the portable telephone A reads profile information in step S41 and displays the profile information on the display part 14. In step S42, the portable telephone A starts up the sub-menu and the user selects, for example, infrared transmission. Thereby, in step S43, the portable telephone A attaches the profile information tag to the profile information of the own portable telephone A, carries out infrared transmission, and thereafter stands ready for reception for a certain period of time.

On the other hand, the portable telephone B starts up a menu or the sub-menu in step S51 and the user selects infrared reception. In step S52, the portable telephone B carries out infrared reception of the profile information, and stores the received profile information in a telephone directory of the memory 17. It is noted that the profile information tag is discarded at this time.

After that, in step S53, the portable telephone B determines whether to subsequently carry out infrared transmission of profile information of the own portable telephone B according to a result of analyzing to determine whether the profile information tag has been attached to the received profile information. In this case, the profile information tag has been attached to the profile information as mentioned above (step S53 YES). Therefore, the process automatically proceeds to step S54. When the profile information tag has not been attached to the received profile information (step S53 NO), the portable telephone B finishes the process.

In step S54, the portable telephone B reads the profile information of the own portable telephone B from the memory 17, transmits the read profile information through infrared rays (infrared transmission) in return, and completes the exchange of profile information, in step S55. It is noted that at this time, the portable telephone B does not attach the portable information tag to the profile information.

When having received the profile information transmitted by the portable telephone B through infrared rays (infrared transmission) during the standing ready for reception for the certain period of time, the portable telephone A stores the profile information received through infrared rays (infrared reception) in step S44 in a telephone directory of the memory 17. Then, the portable telephone A completes the exchange of profile information in step S45. In step S45, such a message as “profile information exchange completion” may be displayed on the display part 14.

Thus, depending on whether the profile information tag has been attached to the profile information in step S53, the portable telephone B determines whether to subsequently transmit the profile information of the own portable telephone B. Then, in a case where the profile information tag has been attached to the profile information (step S53 YES), the portable telephone B automatically transmits the profile information through infrared rays (infrared transmission) in step S54 and completes the exchange of profile information in step S55. Therefore, the user's extra operations are not required at the portable telephone B, and it is possible to omit the user's trouble.

Further, merely when the portable telephone A displays the profile information in step S41 and the user selects infrared reception in step S42, the portable telephone A automatically carries out infrared reception of the profile information from the portable telephone B in step S44. Then, the portable telephone A completes the exchange of profile information in step S45. Therefore, at the portable telephone A, the user's extra operations are not required, and it is possible to omit the user's trouble.

Further, according to the first embodiment, a configuration is provided by which the profile information tag is attached to the profile information of the portable telephone A and the profile information is transmitted. Further, another configuration is provided by which in a case where the portable information tag has been attached to the profile information received by the portable telephone B, the portable telephone B reads the profile information of the own portable telephone B and transmits the profile information to the portable telephone A. Thus, the first embodiment can be easily realized only by adding these two configurations.

It is noted that as indicated by a broken line in FIG. 8, step S47 may be inserted between steps S43 and S44. In this configuration, the portable telephone A determines in step S47 whether to carry out infrared reception of profile information (step S43) subsequently to infrared transmission of profile information (step S42). More specifically, in this case, only when the user of the portable telephone A has selected “to subsequently receive” (S47 YES), the portable telephone A carries out infrared reception of profile information transmitted by the portable telephone B through infrared rays (step S44).

### <Second Embodiment of Whole Process at Time of Profile Information Exchange>

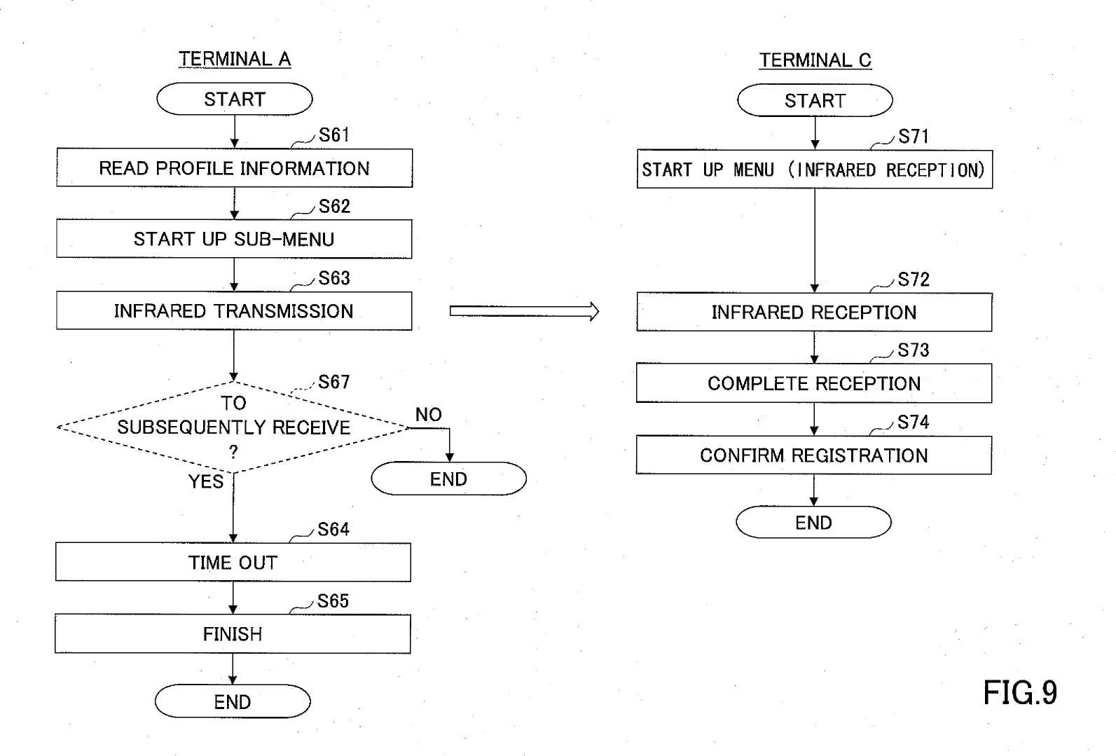

FIG. 9 depicts a flowchart of a whole process at a time of a profile information exchange according to a second embodiment of the present invention. According to the second embodiment, a case is assumed where a portable telephone A at a transmission side is capable of attaching and identifying the profile information tag. However, a portable telephone B at a reception side is not capable of identifying the profile information tag. It is noted that the portable telephone A may be referred to as a terminal A and the portable telephone C may be referred to as a terminal C.

In FIG. 9, the portable telephone A reads profile information in step S61 and displays the profile information on the display part 14. In step S62, the portable telephone A starts up the sub-menu and the user selects, for example, infrared transmission. Thereby, in step S63, the portable telephone A attaches the profile information tag to the profile information of the own portable telephone A, carries out infrared transmission, and thereafter stands ready for reception for a certain period of time.

On the other hand, the portable telephone C starts up a menu or the sub-menu in step S71 and the user selects infrared reception. In step S72, the portable telephone C carries out infrared reception of the profile information, and stores the received profile information in a telephone directory of the memory 17. It is noted that the profile information tag is discarded at this time. The portable telephone C is not capable of identifying the profile information tag attached to the profile information, and therefore, the portable telephone C completes the infrared reception of the profile information in step S73. In step S74, the portable telephone C displays the received profile information on the display part 14 so that the user can confirm registration, i.e., storage of the profile information, and the portable telephone C finishes the process.

Since no infrared transmission has been carried out by the portable telephone C during the standing ready for reception for the certain period of time, the portable telephone A times out in step S64. Then, the portable telephone A finishes transmission of the profile information in step S65. In step S65, such a message as “profile information transmission completion” may be displayed on the display part 14.

Thus, even in the case where the portable telephone at the reception side is not capable of identifying the profile information tag, an exchange of profile information can be carried out as in the related art although time is consumed.

It is noted that as indicated by a broken line in FIG. 9, step S67 may be inserted between steps S63 and S64. In this configuration, the portable telephone A determines in step S67 whether to carry out infrared reception of profile information subsequently to infrared transmission of profile information (step S63). More specifically, only when the user of the portable telephone A has selected “to subsequently receive” (S67 YES), the portable telephone A carries out infrared reception of profile information transmitted from the portable telephone C (not depicted).

### <Data Format at Time of Communication>

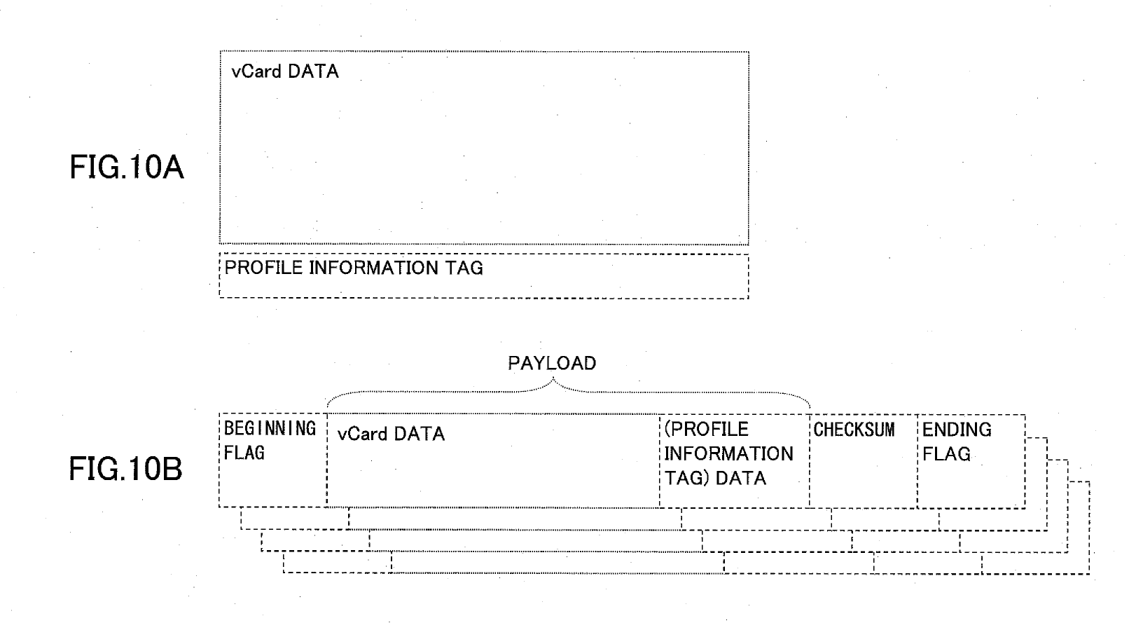

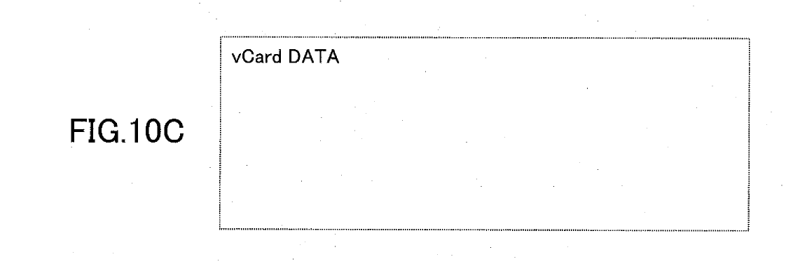

FIGS. 10A, 10B and 10C depict a data format of profile information when the profile information is transmitted through infrared communication. Profile information of vCard data indicated as being enclosed by a solid line in FIG. 10A is read from the memory 17, and the profile information tag “DATA: PROFILE” indicated as being enclosed by a broken line in FIG. 10A is attached to the profile information of vCard data.

Next, the profile information to which the profile information tag has been attached is divided into plural packets to be transmitted through infrared communication. Each of the plural packets has, as depicted in FIG. 10B, a beginning flag, a payload that stores thus divided profile information including profile information tag data, a checksum and an ending flag.

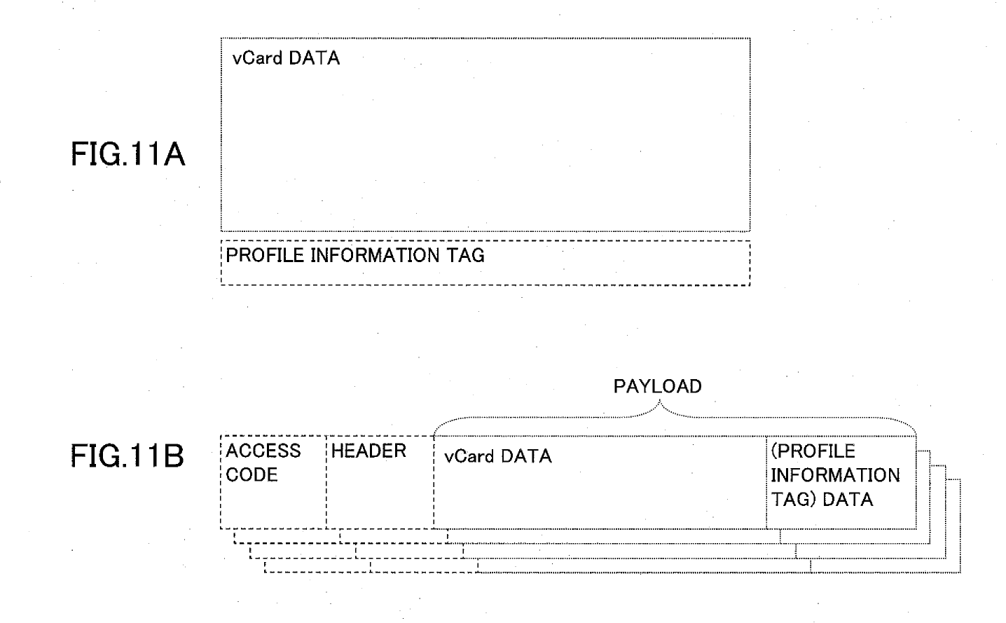

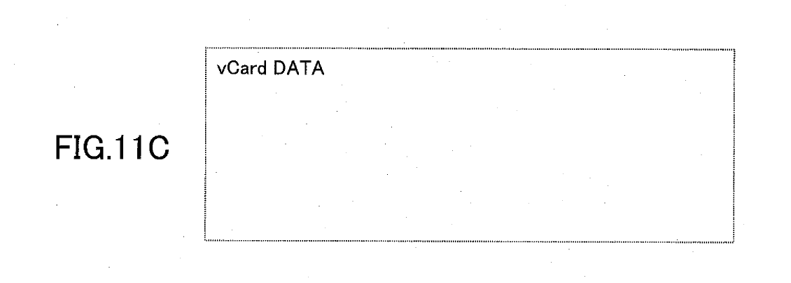

At a reception side, the plural packets depicted in FIG. 10B are received, the profile information to which the profile information tag data has been attached is analyzed from the payload of each of the plural packets, and the profile information of vCard data from which the profile information tag has been discarded, as depicted in FIG. 11C, is stored in a telephone directory of the memory 17.

FIGS. 11A, 11B and 110C depict a data format of profile information when the profile information is transmitted through short distance wireless communication. Profile information of vCard data indicated as being enclosed by a solid line in FIG. 11A is read from the memory 17, and the profile information tag “DATA: PROFILE” indicated as being enclosed by a broken line in FIG. 11A is attached to the profile information of vCard data.

Next, the profile information to which the profile information tag has been attached is divided into plural packets to be transmitted through short distance wireless communication. Each of the plural packets has, as depicted in FIG. 11B, an access code, a header and a payload that stores thus divided profile information including profile information tag data.

At a reception side, the plural packets depicted in FIG. 11B are received, the profile information to which the profile information tag data has been attached is analyzed from the payload of each of the plural packets, and the profile information of vCard data from which the profile information tag has been discarded, as depicted in FIG. 11C, is stored in a telephone directory of the memory 17.

According to the embodiments of the present invention, it is possible to make easier users' operations in information exchange.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that various changes, substitutions, and alterations could be made hereto without departing from the spirit and scope of the invention.

What is claimed is:

1. An information exchange method comprising:
reading exchange target information of a first mobile communication terminal apparatus to be exchanged stored in a memory of the first mobile communication terminal apparatus, attaching identification information for indicating as being the exchange target information to the exchange target information, and transmitting the exchange target information to a second mobile communication terminal apparatus;
storing the exchange target information in a memory of the second mobile communication terminal apparatus, and when having determined that the identification information is attached to the exchange target information, reading exchange target information of the second mobile communication terminal apparatus to be exchanged stored in the memory of the second mobile communication terminal apparatus, transmitting the read exchange target information to the first mobile communication terminal apparatus in return; and
receiving the exchange target information transmitted from the second mobile communication terminal apparatus in return, and storing the received exchange target information in the memory of the first mobile communication terminal apparatus.

2. The information exchange method as claimed in claim 1, further comprising
selecting, by the first mobile communication terminal apparatus, to determine whether to receive the exchange target information transmitted from the second mobile communication terminal apparatus in return.

3. A mobile communication terminal apparatus comprising:
a transmission part configured to read exchange target information to be exchanged stored in a memory, attach identification information for indicating as being the exchange target information, and transmit the exchange target information to another mobile communication terminal apparatus; and
a reception part configured to receive exchange target information to be exchanged transmitted from the other mobile communication terminal apparatus, and store the received exchange target information in the memory.

4. The mobile communication terminal apparatus as claimed in claim 3, further comprising:
an analysis part configured to analyze to determine whether identification information for indicating as being the exchange target information is attached to the exchange target information received by the reception part; and
a return part configured to, when the analysis part has determined that the identification information is attached to the exchange target information, read the exchange target information stored in the memory and transmit the read exchange target information to the other mobile communication terminal apparatus in return.

5. The mobile communication terminal apparatus as claimed in claim 4, wherein
the reception part is configured to have a reception selection part configured to select to determine whether to receive the exchange target information transmitted from the other mobile communication terminal apparatus in return.

6. A non-transitory computer readable information recording medium storing a program which, when executed by one or more processors, causes a mobile communication terminal apparatus to carry out:
reading exchange target information to be exchanged stored in a memory, attaching identification information for indicating as being the exchange target information, and transmitting the exchange target information to another mobile communication terminal apparatus; and
receiving exchange target information to be exchanged transmitted from the other mobile communication terminal apparatus, and storing the received exchange target information in the memory.
